(19) United States
(12) Patent Application Publication
(10) Pub. No.: US 2004/0238984 A1
(43) Pub. Date: Dec. 2, 2004

(54) Method for producing and recycling operating material for enamelling purposes

(76) Inventor: Volker Beckord, Hannover (DE)

Correspondence Address: Patrick W Rasche, Armstrong Teasdale, One Metropolitan Square, Suite 2600, St. Louis, MO, 63102, US

(21) Appl. No.: 10/482,608

(22) PCT Filed: Apr. 15, 2002
(86) PCT No.: PCT/EP02/04165

(30) Foreign Application Priority Data
Jun. 29, 2001 (EP) PCT EP01 07499
Jun. 29, 2001 (EP) PCT EP01 07501

(51) Int. Cl. B29C 45/00

(52) U.S. Cl. 264/37.33

(57) ABSTRACT

The present invention relates to a method of manufacturing and recycling processing means to be used during the painting or coating of vehicle parts in order to hold, cover, or transport such parts, or fix them in position or for the assembly of such parts. The processing means are produced by injection moulding, and after use are ground up while still in the painted state and subsequently used as raw material, in pulverized form, for an injection-moulding procedure to manufacture such processing means.

The invention relates to a method of manufacturing and recycling processing means that are used, for example, during the operations of painting or coating vehicle parts, to hold, shield, or transport such parts or to attach or assemble them.

Processing means of the kind in question serve, e.g., to keep parts that are to be painted—such as doors, plates for the front and rear of the vehicle, sill plates and similar movable parts—in a specified position in order to prevent such parts from being touched, striking against one another or oscillating during a painting operation. The goal of this measure is to ensure that the paint will be applied as specified because the part occupies a predetermined position with respect to a paint-application device.

These processing means are constructed specifically for the particular area of application and in dependence on the particular part or model to be painted, and at present are customarily made of metal.

Because these processing means are themselves coated during the painting operation, after every time they are used or after each cycle the paint must be removed mechanically, thermally or chemically, in order to avoid the possibility that parts to be newly painted become contaminated by pieces of already dried paint layers that have flaked off; such paint removal is associated with considerable expense, to say nothing of the environmental aspects.

In the context of this invention the term “paint” is used for all the customary colouring and coating agents that are applied by spraying, dipping, spreading on with brushes etc. or similar coating techniques. The term “painting” is to be understood as having a correspondingly general meaning.

Given the above considerations, there is a great need for alternative processing or production accessories that can perform the functions described but do not necessitate elaborate procedures for disposal or cleaning.

A similar set of problems exists for production components that are installed during assembly and become painted, when at the end of their working life the parts must be sent away to be otherwise utilized or discarded. Here again, in order to ensure proper disposal or re-use, it is necessary to remove the paint, which as mentioned above is expensive and usually is not among the customary central tasks of a manufacturer of vehicles, household apparatus or furniture, or a subcontractor thereof. Economical disposal or re-use is thus impossible, as a general rule. Here, again, there is a great need for alternative solutions.

It is hence the objective of the present invention to make available a method of manufacturing alternative processing means and/or production means or parts in which the above-mentioned problems are solved, and which provides parts that satisfy the requirements during manufacturing/painting or during the working life of a part, and that can be re-used in a simple manner that takes account of ecological as well as economical aspects.

This objective is achieved by a method according to claim 1, by an application according to claim 9, and by a processing means according to claim 10.

It is an essential point of the invention that the material from which the processing means is manufactured is not, as is conventional, metal; instead, materials are employed that can be recycled while in the painted state in an ecologically and economically simple manner and can be re-used without elaborate pretreatment or subsequent treatment. The processing means in accordance with the invention are initially produced by an injection-moulding procedure and after each use are ground up while still in the painted state, and then the resulting powder can be used again directly to produce processing means, so that a new cycle is thus begun.

When the plastic materials listed below are used, the entire sequence of manufacture, utilization and recycling is simplified, because after the processing means have been used, there is no longer any need to sort them according to type or to clean them.

At the beginning of their second life cycle, the processing means are disposable goods that have been ground into a powder and are supplied as raw material for a subsequent injection-moulding operation. Because this involves no costs for paint removal and/or sorting, as it is unnecessary to ensure that functional surfaces are in the correct state, expenditure is considerably reduced.

According to one embodiment of the invention, a certain amount of original raw material is added to the material that has been recycled for injection moulding. This can be advantageous particularly if the quality of the paint-contaminated recycling product is no longer satisfactory. By addition of the original raw material, the functionality of the processing means can be maintained, with the above-mentioned advantages.

It should be emphasized here that by warming prior to the injection-molding operation, homogenization of the paint itself, the painted processing means and the original raw material is achieved, which ensures permanent preservation of the optimal properties of the processing means. There is no need to worry about decay or disintegration as a result of inhomogeneity.

According to one embodiment of the invention, it has proved useful for the amount of added original raw material to be in the range from 3% to 30% by weight, preferably from 5% to 20% by weight, and most preferably in the range 8-15% by weight. As a general rule, however, it is sufficient to add only a small amount, i.e. original raw material amounting to approximately 10% of the total weight, in order to guarantee that the recycling product can be used several times with no sacrifice of its mechanically and thermally stable properties, especially with respect to injection moulding.

According to another embodiment of the invention, the original raw material is a thermally stable plastic that can be used in the long term at temperatures in the range from 150° C. to 280° C., preferably above 170° C. Plastics with such a long-term temperature tolerance exhibit characteristics favourable for production by injection moulding, because this property ensures thermoplastic deformability, on one hand, and on the other hand also mechanical stability when the material has cooled down. Hence ageing of such plastics is delayed.

According to another embodiment, the original raw material is composed of one or more of the following substances: polysulfone, poly(arylether)ketone, poly(ethersulfone), ABS (acrylonitrile/butadiene/styrol), polyamide or similar thermoplastic materials (cf. plastics compendium Vogel Fachbuch, 4th edition 1996, by Dr. A. Frank, ISBN 3-8023-1589-8).

Particularly suitable for the method in accordance with the invention are plastics reinforced with fibres, such as glass or carbon fibres or kevlar or similar reinforcing materials. Preferably, therefore, a fibre-reinforced plastic is used as the original raw material.

The best plastic with respect to acquisition costs, recyclability, suitability for injection moulding (optimal flow behaviour) and mechanical properties, in particular even at high temperatures such as are used in ovens for the heat-curing of paints, has proved to be glass-fibre-reinforced polyamide.

According to another embodiment of the invention the processing means, or the original raw material, is reinforced with a filler in a proportion by weight of 0.1 to 40% filler material. By adding an amount of filler within this range of variation, depending on what is required regarding flow behaviour during injection moulding as well as shape stability and solidity of the processing means during the painting operation, a desirable optimum can be achieved.

Another advantage of the method, and of a product of the method in accordance with the invention, is that the adherence of paint to glass-fibre-reinforced polyamide is better than to metal, with respect to stability and invulnerability to impacts, so that less paint will flake off, which reduces the risk of contamination of a newly coated surface.

This property of optimized paint adherence to plastics, such as fibre-reinforced plastics in general and glass-fibre-reinforced polyamide in particular, has been demonstrated in a particularly advantageous way when the product of the invention is employed as a vehicle component, in particular as a component of a vehicle body or a part to be attached thereto, because these structures are often subjected to large mechanical forces. In principle, however, the method is also suitable for the manufacture of, or making holders for, items of furniture and also products associated with travel on roads, e.g. street signs, channel covers and other structures employed in this area, as well as in the household context.

The product of this method is especially suitable for vehicle components such as front or rear flaps, mud guards or side walls. Here, again, the plastic parts produced and painted in accordance with the invention can be practically 100% re-used for an additional injection-moulding procedure.

In correspondence with the above considerations, according to another embodiment of the invention it is proposed to employ the product of the method as a means of assisting production, for example as a masking means during a painting process or as retaining, fixation or transport means.

Thus the method in accordance with the invention represents an ecological concept, in that it renders the removal of paint superfluous, whether by mechanical, thermal or chemical procedures, because the processing means in accordance with the invention can be converted while still in the painted state, after being ground up or pulverized, into a raw material for subsequent injection moulding. This recycling sequence can be repeated nearly as often as desired, given that small amounts of the original raw material are added whenever they are needed in order to optimize the characteristics of the injection-moulding material.

Employment of the processing means in accordance with the invention is also superior regarding economical aspects, as the metal alternatives that have been customarily used are usually expensive. In particular, the user (e.g., the manufacturer of the houshold equipment or vehicle) is not encumbered with the effort of acquisition and disposition of the processing means, because this work is performed by the subcontractors responsible for the injection-moulding technology. In contrast to the ultimate manufacturers, the latter have as their central task the pulverization of bulk material and the consumption of the recycling product in order to construct the processing means. Because such processing means find application in many branches of industry, these subcontractors have a strong incentive to produce them in a rational and economical manner.

At this juncture it should be pointed out that all of the parts and procedural steps described above are claimed as essential to the invention, individually or in any combination.

Modifications thereof are familiar to a person skilled in the art.

1. Method of manufacturing and recycling processing means for use in painting or coating of parts, including holding, covering or masking, transporting, fixation or assembly of such parts, said method comprising the following steps:
a) producing the processing means by injection moulding;
b) grinding up the processing means after each use, while they are still in the painted state; and
c) returning a resulting powder to be used as raw material for a subsequent injection-moulding procedure to produce the processing means.

2. Method according to claim 1, wherein when the injection moulding method is used in a recycling system, an arbitrary proportion of original raw material is added.

3. Method according to claim 2, wherein an added amount of original raw material is in the range from 3% to 30% by weight, preferably in the range from 5% to 20% by weight, and especially preferably in the range from 8% to 15% by weight.

4. Method according to claim 2, wherein a thermally stable plastic is employed as original raw material which can be used in the long term at a temperature in the range from 150° C. to 280° C., preferably above 170° C.

5. Method according to claim 2, wherein the original raw material consists of one or more of the following substances: polysulfone, poly(arylether)ketone, poly(ethersulfone), ABS (acrylonitrile/butadiene/styrol), polyamides.

6. Method according to claim 3, wherein a fibre-reinforced plastic is used as original raw material.

7. Method according to claim 3, wherein glass-fibre-reinforced polyamide is used as original raw material.

8. Method according to claim 3, wherein the processing means is reinforced with filler, in particular fibres, in a proportion of 0.1% to 40% by weight.

9. Method of employing the product of the method according to claim 1 as a processing means, comprising utilizing the processing means for purposes of at least one of paint application, a shielding or masking means, a holding means, fixation means, and transport means.

10. Processing means manufactured by a method according to claim 1.
